(19) United States
(12) Patent Application Publication
(10) Pub. No.: US 2015/0325069 A1
(43) Pub. Date: Nov. 12, 2015

(54) SECURITY ASSET MANAGEMENT SYSTEM, METHOD, AND RECEPTACLE THEREFOR

(71) Applicant: Key Systems, Inc., Fishers, NY (US)

(72) Inventors: George H. Eckerdt, Victor, NY (US); George Mastrodonato, Rochester, NY (US); Thomas Rockwell, Rochester, NY (US)

(21) Appl. No.: 14/706,375

(22) Filed: May 7, 2015

Related U.S. Application Data
(60) Provisional application No. 61/990,707, filed on May 8, 2014.

(51) Int. Cl. G07C 9/00

(52) U.S. Cl. CPC G07C 9/00111

(57) ABSTRACT

An asset management system can receive and track an asset with preexisting identification circuitry, such as a car fob. In embodiments, the car fob can be received by a receptacle and a sensor, such as an antenna, can be used to receive an identifier from the fob. A lockable drawer can be sized to receive the fob and can bring the fob into proximity with the antenna.

### BACKGROUND

The present invention relates to security asset management systems, and, more specifically, to securing assets that already include identification circuitry.

A security asset management system (SAM) can use circuitry to monitor, secure, and/or manage assets, such as keys, computers, weapons, and/or any other object. In some implementations, a SAM can control access to rooms, vehicles, and/or other places and/or objects, directly and/or indirectly. By providing proper credentials, a user can be authenticated and can be granted access to one or more assets. Credentials can be provided directly or indirectly, such as via a keypad on a SAM device, by phoning credentials into a SAM control center, and/or a variety of other ways. Access to assets can thus be managed among and/or restricted to those with proper authorization from an owner and/or user.

In some SAM systems, identification circuitry is included in a fob, can, button, or other device attached to, mounted on, or mounted in an asset to be tracked. In addition, some such systems can positively retain the device in which the identification circuitry is included, such as by using a solenoid to prevent withdrawal of the device from a storage position. Some assets, however, can already include identification circuitry and so would not require an additional device in which identification circuitry would ordinarily be included. Such assets therefore do not have a way to be positively retained in some security asset management systems.

### SUMMARY

According to one embodiment of the present invention, a system for asset management can include at least one tracking communication port selectively coupled to an asset communication port. A database can be included and can be configurable to store one or more asset records. The system can also include a user interface and a controller coupled to the at least one tracking communication port, the database, and the user interface. The controller can identify a user via the user interface, sense when an asset, having the asset communication port, couples to the at least one tracking communication port via its asset communication port, query the asset for at least one unique asset identifier, and store a record corresponding to the at least one unique asset identifier.

Another embodiment of the invention disclosed herein can include an asset tracking device having at least one tracking communication port configured to be removably coupled to an asset communication port. Translation circuitry coupled to the at least one tracking communication port can including a sensor that selectively senses when an asset, having the asset communication port, couples to the at least one tracking communication port via its asset communication port. The translation circuitry can query the asset when present for at least one unique asset identifier and present the at least one unique asset identifier to a controller.

An additional embodiment of the invention disclosed herein can take the form of a security asset manager including a communication bus and at least one tracking communication port configured to be removably coupled to an asset communication port. Translation circuitry coupled to the at least one tracking communication port and the communication bus can sense when an asset, having the asset communication port, couples to the at least one tracking communication port via its asset communication port, query the asset for at least one unique asset identifier, present the at least one unique asset identifier to the communication bus, and a controller coupled to the communication bus, wherein the controller is configured to determine when the asset is coupled to the at least one tracking communication port by receiving the asset's at least one unique asset identifier from the communication bus.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic block diagram illustrating a security asset manager according to embodiments of the invention disclosed herein.

FIG. 2 is a schematic block diagram illustrating a security asset management system according to embodiments of the invention disclosed herein.

FIG. 3 is a schematic diagram illustrating a car fob that can be used with and according to embodiments of the invention disclosed herein.

FIG. 4 is a schematic diagram of a security asset manager including a receptacle according to embodiments of the invention disclosed herein.

FIGS. 5-11 are schematic illustrations of an asset tracking receptacle according to embodiments of the invention disclosed herein.

FIG. 12 is a schematic diagram of a security asset manager including an asset tracking port, such as an asset tracking receptacle, according to embodiments of the invention disclosed herein.

FIGS. 13-16 are schematic flow diagrams of aspects of a method of managing an asset according to embodiments of the invention disclosed herein.

### DETAILED DESCRIPTION

With reference now to FIG. 1, a secure asset management system 100 can include a controller 110 that can monitor asset storage 120 in which assets 122 can be stored. In embodiments, the presence of one or more assets 122 can be monitored and/or detected by controller 110, and controller 110 can use a database 130 to determine whether access should be granted to an asset 122 in asset storage 120. Controller 110 can include, but is not limited to, a computer, a microprocessor, an application specific integrated circuit (ASIC), a field programmable gate array (FPGA), digital circuitry, analog circuitry, or any combination and/or plurality thereof, or any suitable computing device, whether local or distributed. Database 130, as well as software and/or computer program products that can be used to run secure asset management system 100, can be stored on at least one non-transitory computer readable storage medium 112, which can be part of controller 110, can be a standalone device, and/or can be part of another device with which controller 110 can communicate. In embodiments, controller 110 can include or be in communication with non-transitory computer readable storage medium 112 having computer-readable instructions stored thereon in the form of executable code that when executed by controller 110 causes or enables controller 110 to perform the various actions or functions described herein, as well as other actions or functions as can be suitable and/or desired. A user interface 140 can be used to interact with secure asset management system 100 so that administrators can set up, monitor, and/or manage assets 122 with system 100, and so that users can request and/or gain access to assets 122. For example, user interface 140 can include one or more displays, input devices, audio input/output devices, indicator lights, and/or any other device that allows a user to interact with system 100.

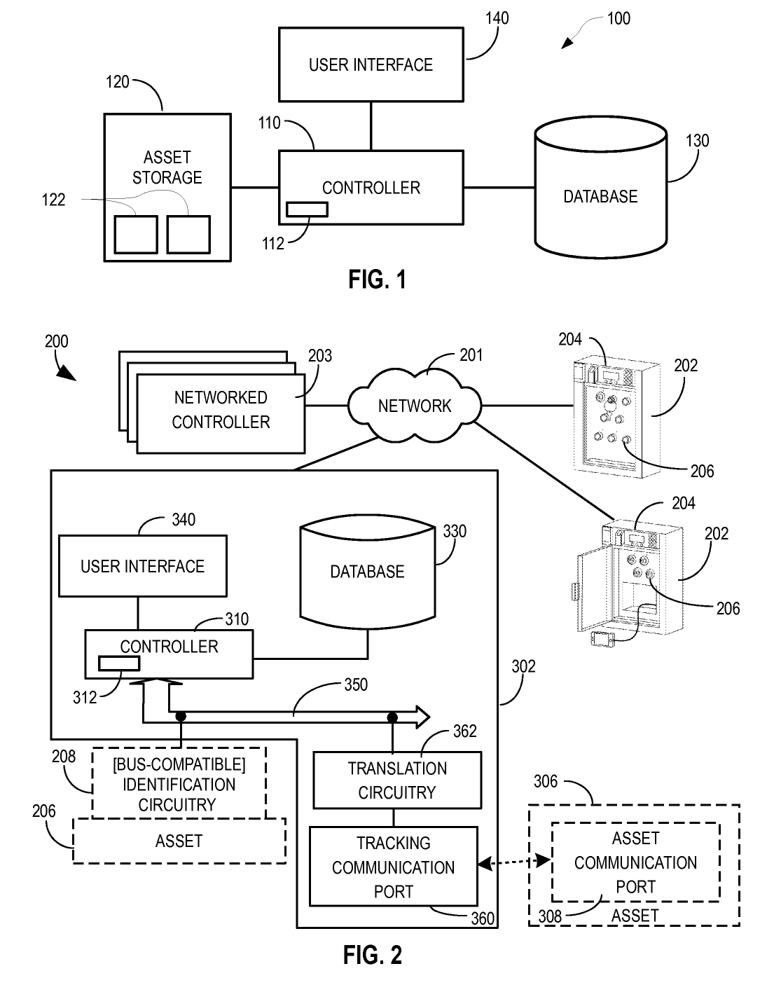

FIG. 2 illustrates an embodiment of a security asset management system 200 that includes at least one security asset manager (SAM) 202. Each SAM 202 can have a user interface as described above, comprising one or more of a variety of user identification (ID) devices, such as a keypad for personal identification number (PIN) entry, a fingerprint reader, and a proximity card reader. Those skilled in the art will understand that other types of user ID devices can be used, such as, but not limited to an iris ID device, a retinal scanning ID device, a hand shape ID device, and a magnetic card reader. Each SAM 202 can also control one or more locked doors and/or lockers (not shown) which can be unlocked by SAM 202 following user identification. Behind the one or more doors, authorized users can reach one or more assets 206. Each asset 206 can be associated with a unique electronic identifier that can be associated with its corresponding asset 206. One suitable non-limiting example of identification circuitry is a touch memory device, such as the DS2401P+ touch memory device from Maxim Integrated. Another non-limiting example of identification circuitry is a radio frequency identification (RFID) tag. Each SAM 202 can further include a controller as described above and that can be removably coupled to or placed in communication with identification circuitry of each asset 206 using a suitable electronic communication scheme, such as, but not limited the One Wire Communication Bus designed by Dallas Semiconductor Corp. The controller can thus detect when identification circuitry of an asset 206 has been connected to or removed from the bus. Since only known authorized users are given access to SAM 202, the respective controller can monitor what assets are present, who has taken removed assets, and who has returned them.

Where security asset management system 200 includes a plurality of SAMs 202, a network 201 can be used to couple SAMs 202 to and/or place SAMs 202 in communication with each other via a network 201. One or more networked controllers 203 can also be coupled to one or more of SAMs 202 via network 201. Network 201 can be, but is not limited to, a local area network (LAN), a wide area network (WAN), a wireless LAN, a wireless WAN, or any combination and/or plurality thereof. In some embodiments, one of networked controllers 203 can be a server running asset management software for coordinating and collecting data from one or more SAMs 202, as well as providing reports on authorized user activity, asset status, and alarms. One suitable example of asset management software is the Global Facilities Management System software available from Key Systems, Inc. In other embodiments, another of networked controllers 201 can include, but is not limited to, a computer, a laptop, a smartphone, and/or a cellular phone which is able to interact via a browser or other web enabled client with either a remote server running asset management software or an embedded web server in one of SAMs 202. In a networked system, such as illustrated in FIG. 2, an asset 206 can be removed from and returned to one of the SAMs 202, and the controllers in each SAM can communicate the asset status to other controllers either directly or via coordinating asset management software.

Some assets include identification circuitry or a communication port used as part of their normal operation. For example, car fobs that include remote control of the cars to which they belong can broadcast an identification code using one or more radio frequencies along with a command, such as to unlock the driver side door. The car can recognize the identification code and execute the command. This type of identification is a form of RFID, and it would be advantageous to use this existing RFID in monitoring and securing such car fobs in a SAM rather than add additional identification circuitry. To take advantage of pre-existing identifiers or the like, embodiments of a SAM 302 shown in FIG. 2 can include hardware and/or software to facilitate communication with and use of the circuitry or communication port of an asset. Several examples of suitable arrangements to achieve these ends can be seen in U.S. Provisional Patent Application 61/837,942, “System and Method for Communication Port Based Asset Management,” filed 21 Jun. 2013 and owned in common herewith, the entire disclosure of which is incorporated by reference.

For example, as seen schematically in FIG. 2, SAM 302 can include, much as the SAM 100 in FIG. 1, a controller 310, which can include a computer-readable storage medium 312, asset storage 320, a database 330, and a user interface 340. In addition, SAM 302 can include a communication bus 350, such as the Dallas One-Wire Bus, with which controller 310 can be coupled to bus-compatible identification circuitry 208 of an asset 206. In addition, for any asset 306 including a communication port 308 or identification circuitry that is not bus-compatible, SAM 302 can include a tracking communication port 360 that can communicate with asset communication port 308, as well as translation circuitry 362 that converts signals from asset 306 into bus-compatible signals. For example, if bus 350 were a One-Wire bus and asset communication port 308 included an RFID tag, tracking communication port 360 could include an RFID sensor, and translation circuitry 362 could translate between the memory space of bus 350 and signals used by the RFID sensor and/or tag.

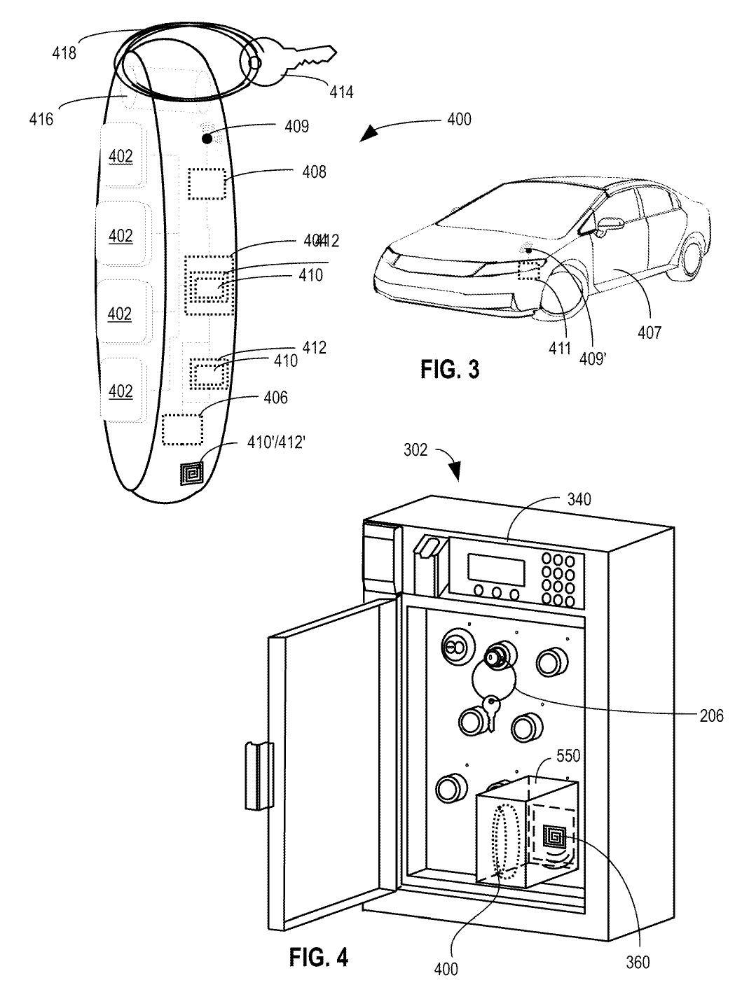

FIG. 3 shows an example of a fob 400 in which one or more buttons 402 can be in communication with control circuitry 404, a power source 406, and a transmitter 408. Each button 402 can cause control circuitry 404 to send an associated command and some form of identifier to a car 407 via transmitter 408 having antenna 409. An identifier can be, for example, an identification code 410 stored in control circuitry 404 or identification circuitry 412, and identification circuitry 412 can be part of control circuitry 404 or separate therefrom. As part of transmitting a command to car 407, control circuitry 404 can retrieve identification code 410 from identification circuitry 412 and transmit the identification code 410 to the car. Fob 400 in embodiments can act as a key, while in other embodiments, fob 400 can be attached to one or more keys 414 via passage 416 and ring or the like 418. FIG. 4 shows the schematically illustrated SAM 302 of FIG. 2, in which assets 206 can be stored and including a receptacle, such as a drawer 550, in which fob 400 or another asset can be stored.

Embodiments of the invention disclosed herein can provide a system, method, and apparatus for recognizing and using identification codes borne by pre-existing identification circuitry in a security asset management system. A SAM can include a drawer sized to hold an asset, such as a car fob, and the SAM can include one or more RFID sensors that can receive and decode signals from the car fob. In some embodiments, each drawer can include a respective RFID sensor, while in other embodiments, fewer RFID sensors can be used. The drawer can be positively retained until a user is authorized to remove the car fob. Upon authorization, the drawer can be released, can be identified by a light source, such as an LED, and the user can pull the drawer open to remove the fob. The drawer can be biased to automatically close upon release by the user, as well as to automatically lock when closed. When the user returns the fob, any empty drawer can be offered by the SAM to hold the fob. Upon authorization, the SAM can release an empty drawer, which can be identified by a light source, such as an LED. The user can then pull the drawer open, place the fob in the drawer, and release the drawer, which can automatically close and lock. In some embodiments, the user can press one of the fob buttons so that the SAM can record the associated identification code, while in other embodiments the SAM can read the code without action by the user.

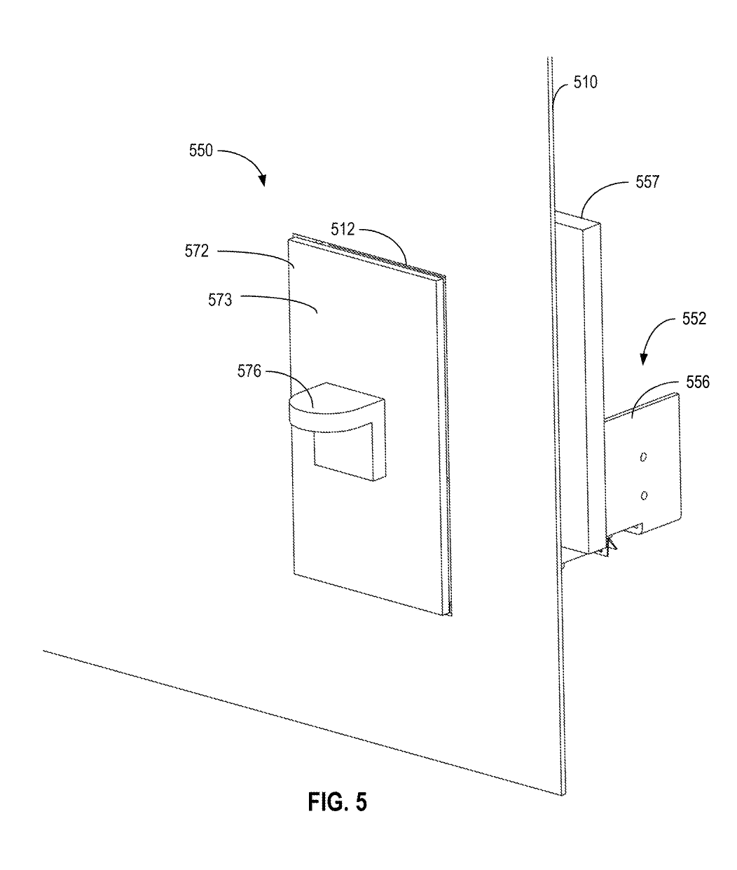

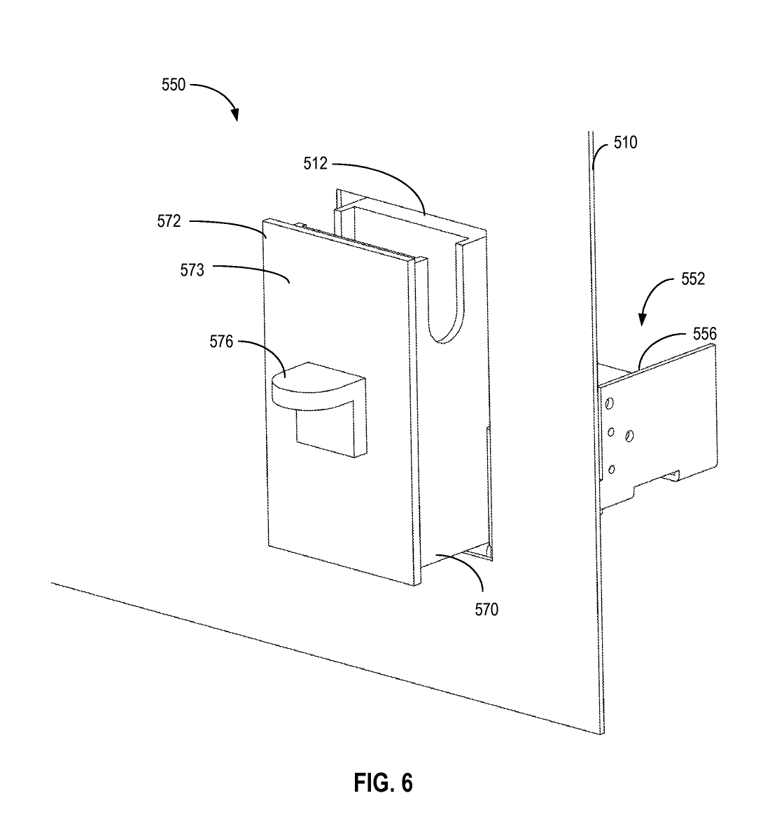

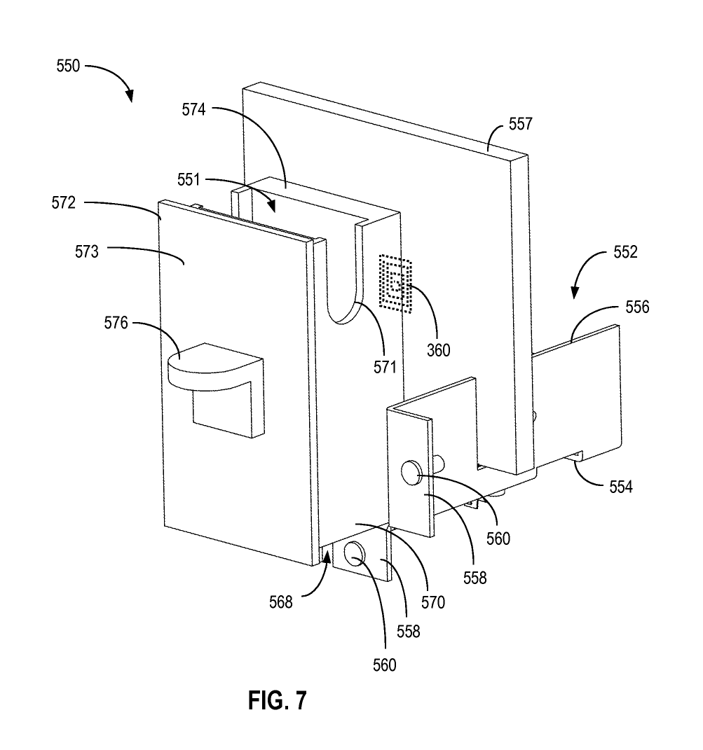

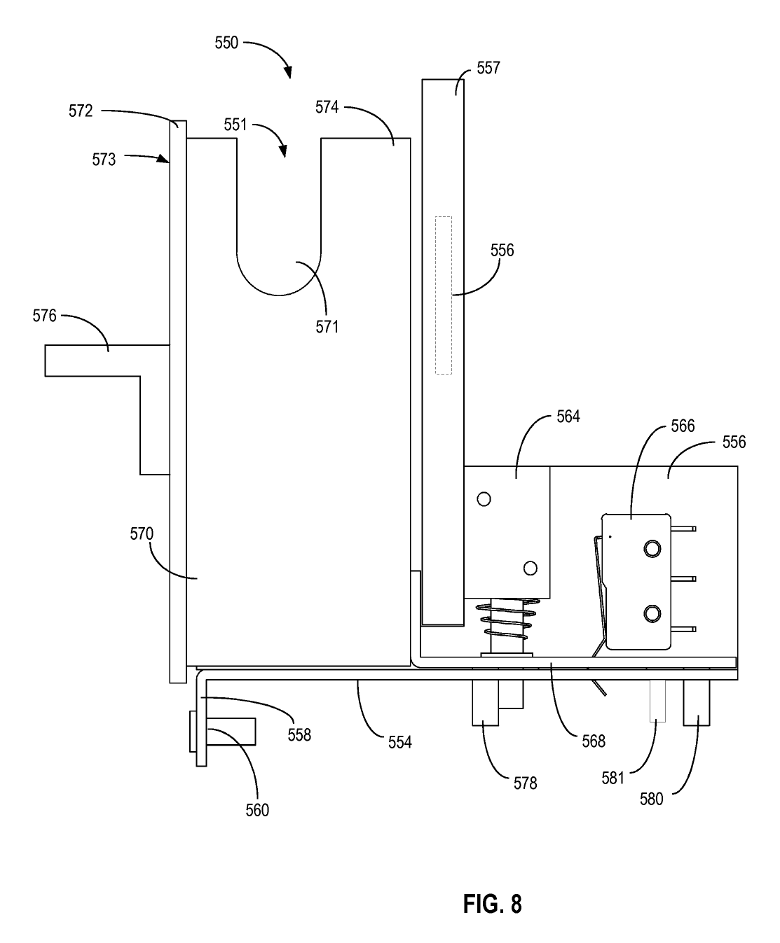

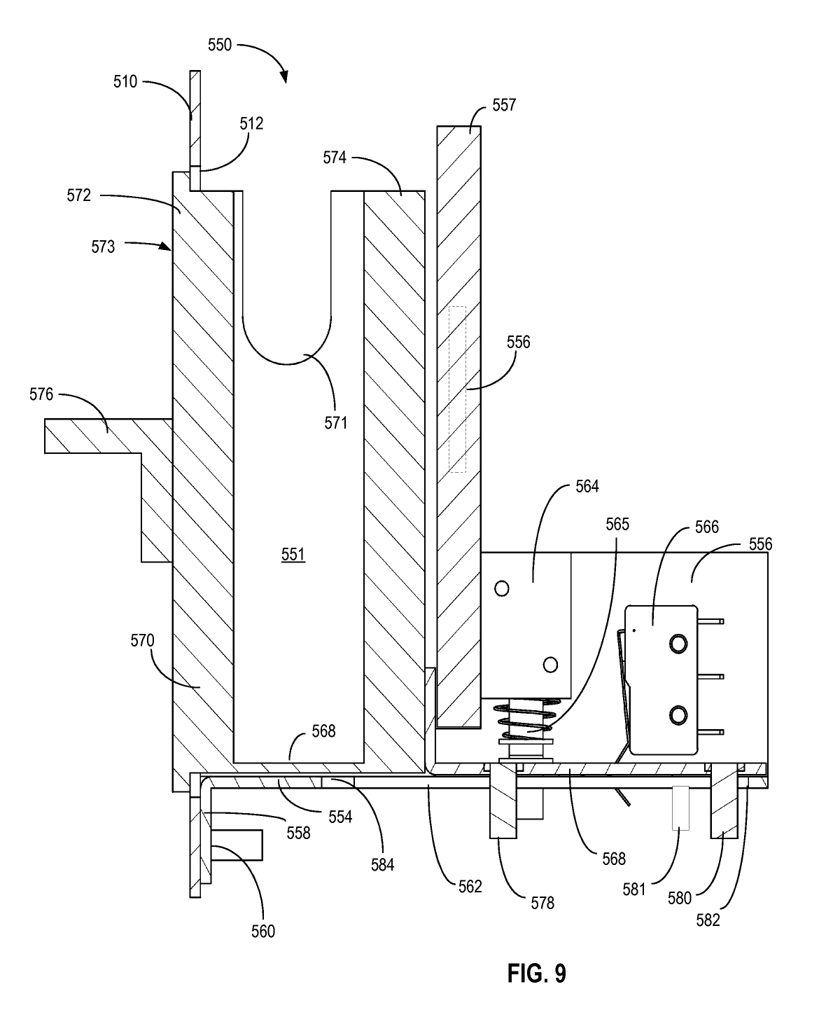

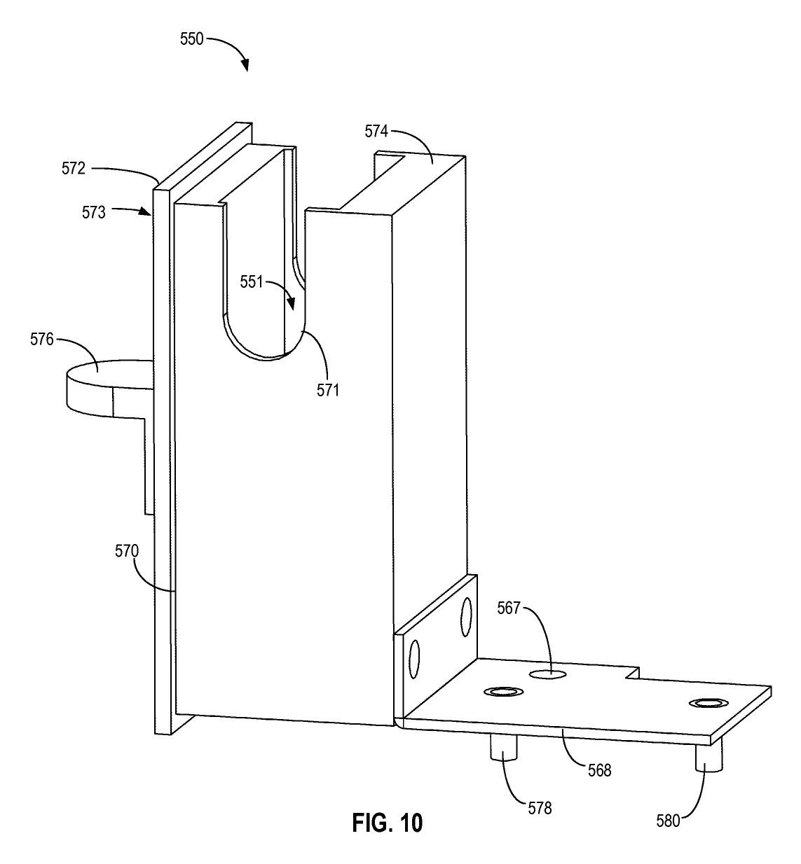

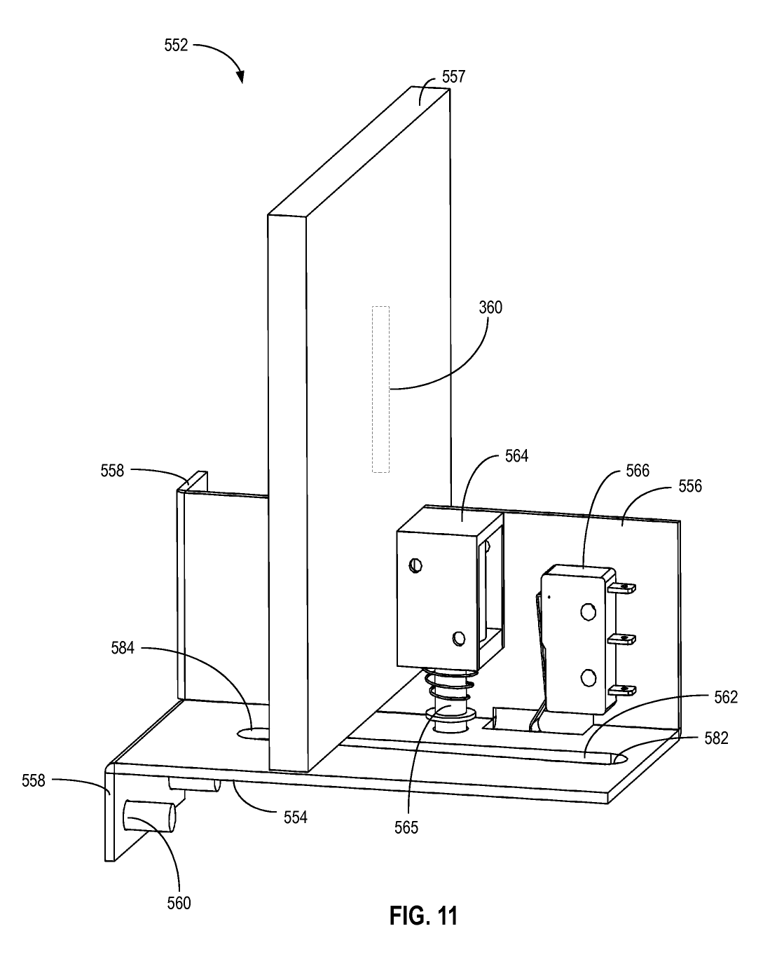

FIGS. 5-11 show an example of the receptacle as drawer 550 in more detail. It should kept in mind that not all of FIGS. 5-11 show all parts discussed below, and the reader is encouraged to refer to another of FIGS. 5-11 if a part or reference numeral is not shown in a FIG. the reader is currently viewing. Drawer 550 can be supported by a bracket 552 that can include a bottom wall 554, a side wall 556, a back wall 557, and one or more flanges 558. Flange 558 can include mounting holes 560 with which bracket 552 can be attached to SAM 302 (FIGS. 1 and 3), such as to a panel 510, so that drawer 550 can pass through an opening 512 in panel 510. Bottom wall 554 can include a slot 562 that can interact with drawer 550 to limit travel of drawer 550 as will be described, as well as a spring mount 581 that can help bias drawer 550 into panel 510 as will be described. A retention device 564, such as a solenoid, can be mounted on a rear portion of side wall 556, as can a presence detector 566, such as a microswitch. Both retention device 564 and presence detector 566 can be mounted and oriented so that they can interact with drawer 550 as will be described.

Drawer 550 can include a bottom wall 568, two side walls 570, a front wall 572, and a back wall 574. Bottom wall 568 and side walls 570 can be sized and arranged to form cavity 551 with substantial space to accommodate fob 400 and to allow drawer 550 to fit through opening 512. In addition, at least one side wall 570 can include an opening 571 sized to allow a user to remove fob 400. Front wall 572 can be wider than opening 512 to prevent drawer 550 from passing too far through opening 512 and to reduce likelihood of tampering. To enhance the reduction, panel 510 can include a recess (not shown) around a perimeter of opening 512 that has a depth substantially equal to a thickness of front wall 572 so that a front surface 573 of front wall 572 can be substantially flush with panel 510 when drawer 550 is closed.

A wall of drawer 550, such as front wall 572, can have a tab 576 extending beyond front wall 572. In operation, a user can pull on tab 576 to open drawer 550. Bottom wall 568 can include a front detent projection 578 positioned and sized to extend through slot 562 of bracket bottom wall 554, as well as a back detent projection 580. A spring 582 can be attached to spring mount 581 and to one of front and rear detent projections 578, 580. In the example shown, spring 582 is attached to front detent projection 578, but where detent projections 578, 580 and spring mount 581 are arranged in different order with suitable modifications to bracket 552, spring 582 can be attached to rear detent projection 580. Front detent projection 578 can further be positioned such that when drawer 550 is closed, rear detent projection 578 rests near or at a rear end 582 of slot 562, and such that when a user pulls drawer 550 open with tab 576, front detent projection 578 can limit travel of drawer 550 by engaging a front end 584 of slot 562. During operation, spring 582 can resist opening of drawer 550 and can pull it closed when a user releases drawer 550. In embodiments, spring 582 is sized so that a biasing force is exerted on drawer 550 when it is closed, thus ensuring complete closure of drawer 550. In addition, while two detent projections 578, 580 have been shown and described, it should be clear that one or more than two such detent projections, or other arrangements, could be used to limit travel of drawer 550.

In the example of FIGS. 5-11, tracking communications port 360 can be included in back wall 557 of bracket 552. While shown in back wall 557, it should be clear that tracking communication port 360 can be in any wall or other location so long as it can suitably communicate with an asset communication port (308 in FIG. 2) when an asset (306 in FIG. 2) is present therein, such as a fob (FIGS. 3-4). In addition, presence detector 566 is shown as a switch with its actuator extending through a slot of bracket 552 into a sensing area in which the actuator can interact with drawer 550, but any suitable switch, arrangement, and/or presence detector could be used. Further, while retention device 564 is shown as a solenoid with its pin 565 extending into a corresponding hole 567 of drawer bottom wall 568, other orientations and/or retention devices could be used.

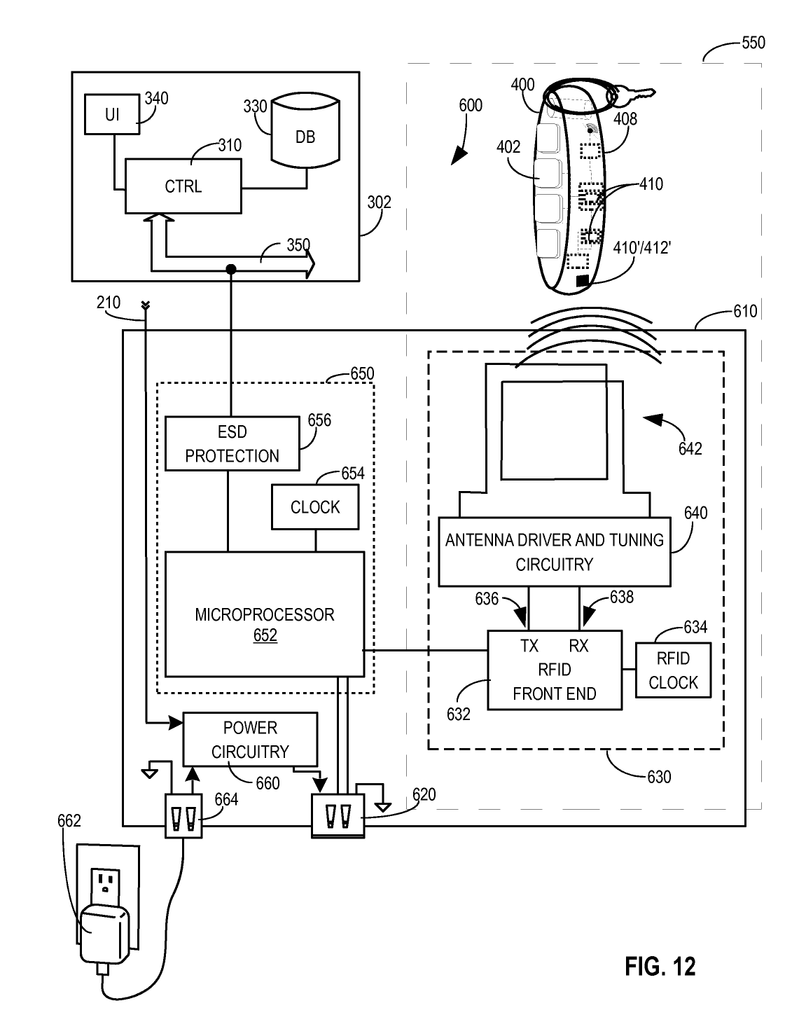

FIG. 12 schematically illustrates an embodiment of a system for asset management having universal serial bus (USB) and radio frequency identification (RFID) tracking communication ports. As shown in FIG. 12, the embodied system for asset management 600 can include a secure asset manager (SAM) 302 as in the embodiment schematically illustrated in FIG. 2. SAM 302 can have a controller 310 with a user interface 340 and a database 330 both coupled to controller 310 as discussed in embodiments above. The SAM 302 can also include a communication bus 350, such as, but not limited to a Dallas Semiconductor 1-Wire Bus as also discussed above. The system 600 can further include an asset tracking device 610, which, in this embodiment, can have two tracking communication ports: a USB tracking communication port 620 and an RFID compatible tracking communication port 630. Additional details of USB tracking communication port 620 can be found in the application incorporated by reference above. RFID compatible tracking communication port 630 can include an RFID front end 632, for example, but not limited to the Multi-Standard Fully Integrated RFID Analog Front End model TRF7960 from Texas Instruments. The RFID compatible tracking communication port 630 can also have an RFID clock 634 coupled to RFID front end 632 to provide a clock at the desired RFID communication frequency. Those skilled in the art are easily familiar with many clock circuits which can provide a desired RFID clock frequency. A transmit connection 636 and a receive connection 638 of the RFID front end 630 are coupled to antenna driver and tuning circuitry 640, which is further coupled to an antenna 642. In this embodiment, the same antenna can be used for transmission and reception, however other embodiments may utilize separate transmission and reception antennas. RFID tracking communication port 630 can be wirelessly coupled with an asset communication port of an asset. For example, an asset can take the form of fob 400, which can include RFID tag 412′ (FIG. 3) and/or RF transmitter 408 (FIG. 3), in drawer 550 with which RFID tracking communication port 630 can be coupled. In embodiments, antenna 642 can be attached to and/or formed in back wall 557 of bracket 552 so that when fob 400 is in drawer 550 and drawer 550 is closed, antenna 642 can be in proximity to fob transmitter 408 and/or RFID identifier 410′/tag 412′. Asset tracking device 630 can also include translation circuitry 650 coupled to tracking communication ports 620, 630. In this embodiment, translation circuitry 650 can include a microprocessor 652 coupled to USB tracking communication port 630 and RFID front end 632 of RFID tracking communication port 630. Microprocessor 652 may be suitably programmed to sense when an asset, such as fob 400, couples to RFID tracking communication port 630 via the asset communication port, and may also be programmed to query the asset via RFID tracking communication port 630 for at least one unique asset identifier, such as identifier 410. In other embodiments, an identification of fob 400 can be initiated by pressing a button 402 (FIG. 3) to transmit a command as described above. In the example shown, translation circuitry 650 can also include a clock 654 coupled to microprocessor 652. Translation circuitry 650 can further include electrostatic discharge (ESD) protection 656 for a communication connection between microprocessor 652 and communication bus 350 of the SAM 302. One non-limiting example for suitable ESD protection 656 is the ESD Protection Device for 1-Wire Interfaces, model DS9503 from Maxim Integrated. Some embodiments may not have ESD protection. One non-limiting example of a suitable microprocessor 652 is the model PIC24FJ256GB110 microprocessor from Microchip Technology Incorporated. In this embodiment, microprocessor 652 can present the at least one unique asset identifier to controller 310 via ESD protection 656 and as facilitated by communication bus 350 coupled to controller 310 as has been discussed previously.

Some assets coupled to asset tracking device 610 in the system for asset management 600 can be charged over its respective tracking communication port to asset communication port connection when coupled. For example, USB devices connected to USB tracking communication port can be charged by virtue of power circuitry 660 connected thereto. Power circuitry 660 in embodiments can be connected to an external power source 662 via a power connector 664, such as a USB port, which can include a voltage supply pin. The voltage supply pin may be configured to receive power from a variety of sources, including a connection from SAM 302. Those skilled in the art can choose from a variety of power circuitry 660 topologies to condition, if necessary, and pass through power to USB tracking communication port 620 or other tracking communication port. Where the tracking communication port is a USB tracking communication port 620, five volts may be provided to the USB VCC pin of connector 664 as known by those skilled in the art, thereby providing charging capability in addition to tracking capability for the coupled asset.

It should be understood that other wireless communication protocols besides RFID can be employed to track assets in embodiments. For example, a form of near field communication (NFC) can be employed instead of or in addition to RFID. Since NFC typically occurs over very short distances, drawer 550 can act as an NFC alignment pad to ensure a user places their asset so that suitable range and/or orientation can be achieved. Many assets include NFC ports, such as, but not limited to smartphones. With some assets having NFC ports, the asset tracking device 610 may be able to query the asset over the NFC connection for a unique asset identifier without modifying the asset, similar to the use of fob 400's existing RF transmissions in embodiments. Some NFC-enabled assets, however, may need a software application to be installed on the asset and configured to provide a unique asset identifier in response to NFC communications from the asset tracking device 610. The software application may include instructions executable by a machine (the asset) and tangibly embodied on at least one program storage device. The instructions are for performing a method of asset management, wherein the method includes monitoring an asset communication port for an identification query from a tracking communication port. The method also includes sending at least one unique identifier to the tracking communication port via the asset communication port. In the case where the tracking communication port and the asset communication port are NFC-compatible, the communications by such an application could take place wirelessly with an NFC protocol. The use of NFC protocols is well within the capabilities of those skilled in the art.

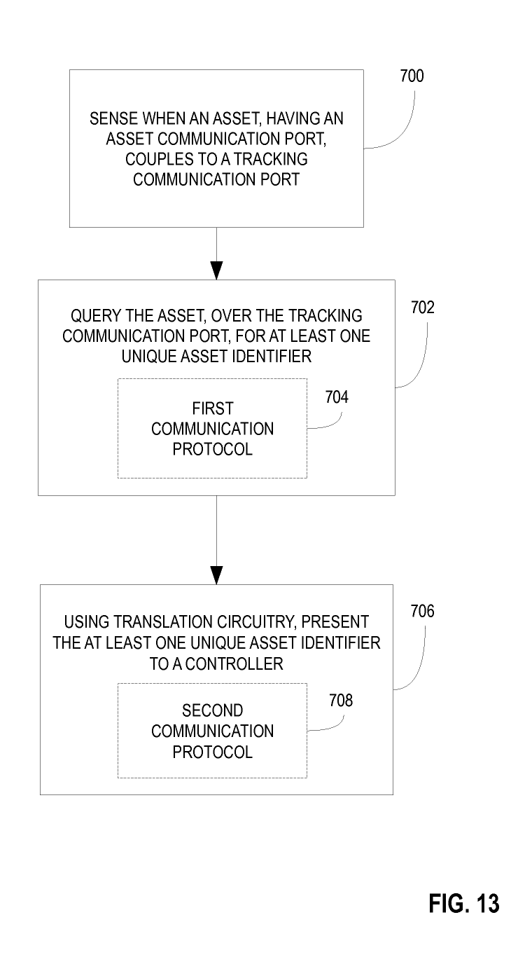

FIG. 13 illustrates one embodiment of a method of asset management. In step 700, an asset having an asset communication port is sensed when it couples to a tracking communication port. This can be accomplished, for example, with translation circuitry coupled to a tracking communication port as discussed above. In step 702, the asset is queried, over the tracking communication port, for at least one unique asset identifier. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can also be accomplished, for example, with translation circuitry coupled to the tracking communication port as discussed above. In some embodiments, this query may occur using a first communication protocol 704. Non limiting examples of a first communication protocol include a radio frequency identification (RFID) protocol, a radio frequency (RF) protocol, a near field communication (NFC) protocol, a Bluetooth protocol, a universal serial bus (USB) protocol, a firewire protocol, a serial communication protocol, a parallel communication protocol, and an optical communication protocol. Examples of unique asset identifiers have also been discussed above, and may include, but are not limited to a media access control (MAC) address, a vendor identification (VID), a product identification (PID), a product serial string, or any combination thereof. In step 706, using translation circuitry, the at least one unique asset identifier is presented to a controller. In some embodiments, this presentation may occur using a second communication protocol 708. Non-limiting examples of a second communication protocol include a 1-Wire communication protocol and a communication bus protocol.

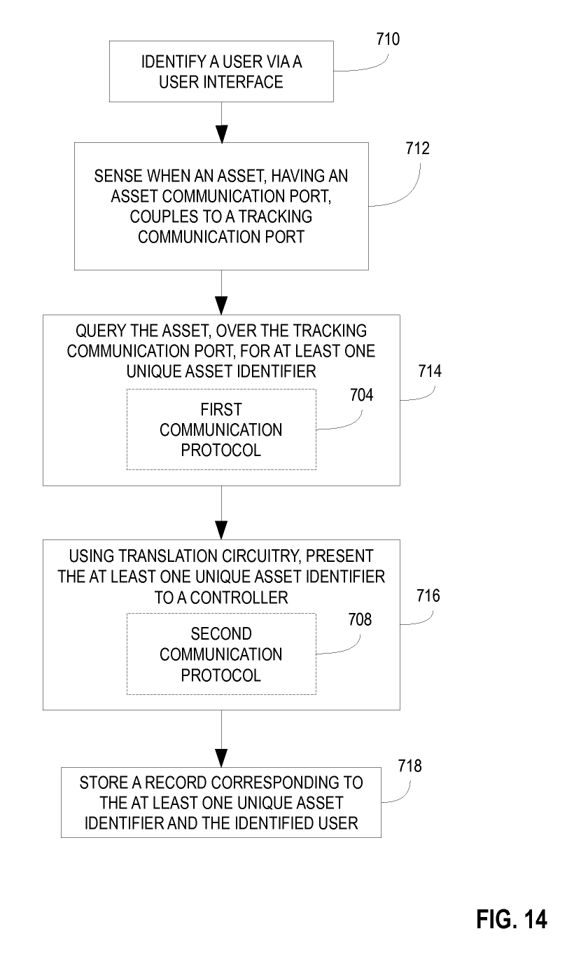

FIG. 14 illustrates another embodiment of a method of asset management. In step 710, a user is identified via a user interface. As discussed previously, examples of a suitable user interface include, but are not limited to a keypad, a fingerprint reader, a proximity card reader, an iris identification device, a retinal scanning identification device, a hand shape identification device, and a magnetic card reader. In step 712, an asset having an asset communication port is sensed when it couples to a tracking communication port. This can be accomplished, for example, with translation circuitry coupled to a tracking communication port as discussed above. In step 714, the asset is queried, over the tracking communication port, for at least one unique asset identifier. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can also be accomplished, for example, with translation circuitry coupled to the tracking communication port as discussed above. In some embodiments, this query may occur using a first communication protocol 704 as discussed previously. In step 716, using translation circuitry, the at least one unique asset identifier is presented to a controller. In some embodiments, this presentation may occur using a second communication protocol 708 as also discussed previously. In step 718, a record is stored corresponding to the at least one unique asset identifier and the identified user. Such a record could be stored in a database or other storage or memory. One example of a record stored could include the name and/or identification of the user identified via the user interface and a list of one or more assets removed and/or returned by the user. Such a record may also include information showing the date/time the transaction took place and/or an alarm or report status for the transaction.

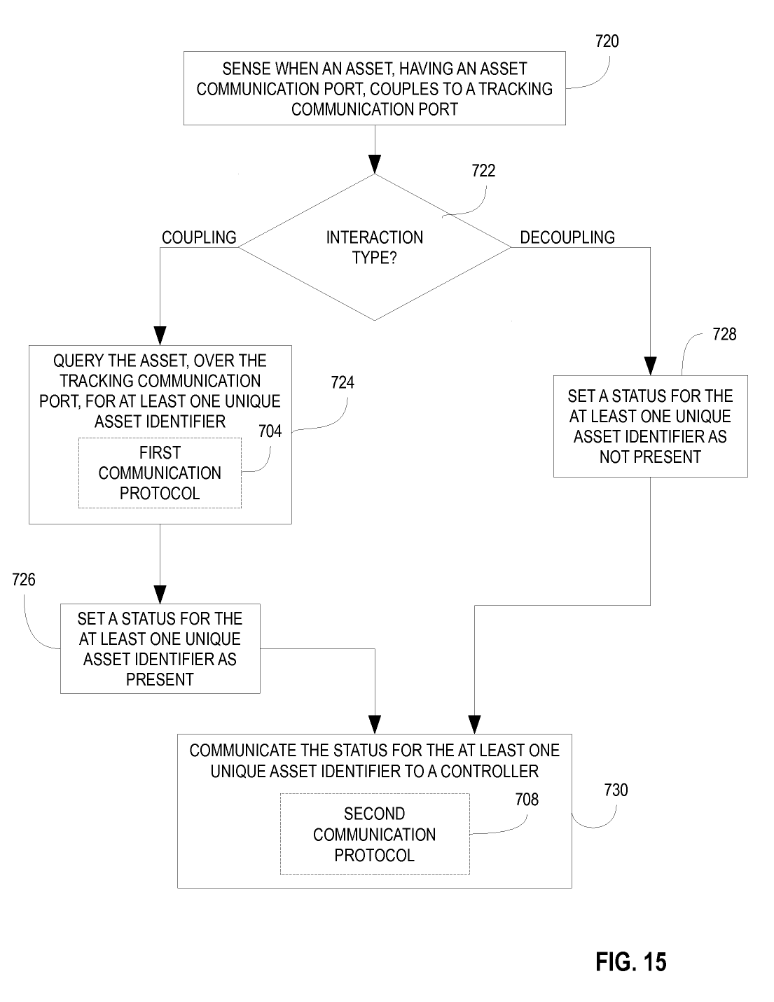

FIG. 15 illustrates a further method of asset management. In step 720, an asset having an asset communication port is sensed when it interacts with a tracking communication port. This can be accomplished, for example, with translation circuitry coupled to a tracking communication port as discussed above. The interaction between the asset communication port and the tracking communication port can be a coupling, for example, when the asset is returned and plugged into the tracking communication port. Alternatively, the interaction between the asset communication port and the tracking communication port can be a decoupling, for example, when the asset is removed and unplugged from the tracking communication port.

A determination 722 is made whether or not the sensed interaction of the asset communication port with the tracking communication port is a coupling or a decoupling. If the interaction comprises a coupling, then in step 724, the asset is queried over the tracking communication port for at least one unique asset identifier. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can also be accomplished, for example, with translation circuitry coupled to the tracking communication port as discussed above. In some embodiments, this query may occur using a first communication protocol 704 as discussed previously. In step 726, a status for the at least one unique asset identifier is set as present. Alternatively, if determination 722 finds that the interaction comprises a decoupling, then in step 728, the status for the at least one unique asset identifier is set as not present. Whether the interaction was a coupling or a decoupling, after the status is set to present or not present, the status for the at least one unique asset identifier is communicated to a controller in step 730. In some embodiments, this communication may occur using a second communication protocol 708 as also discussed previously.

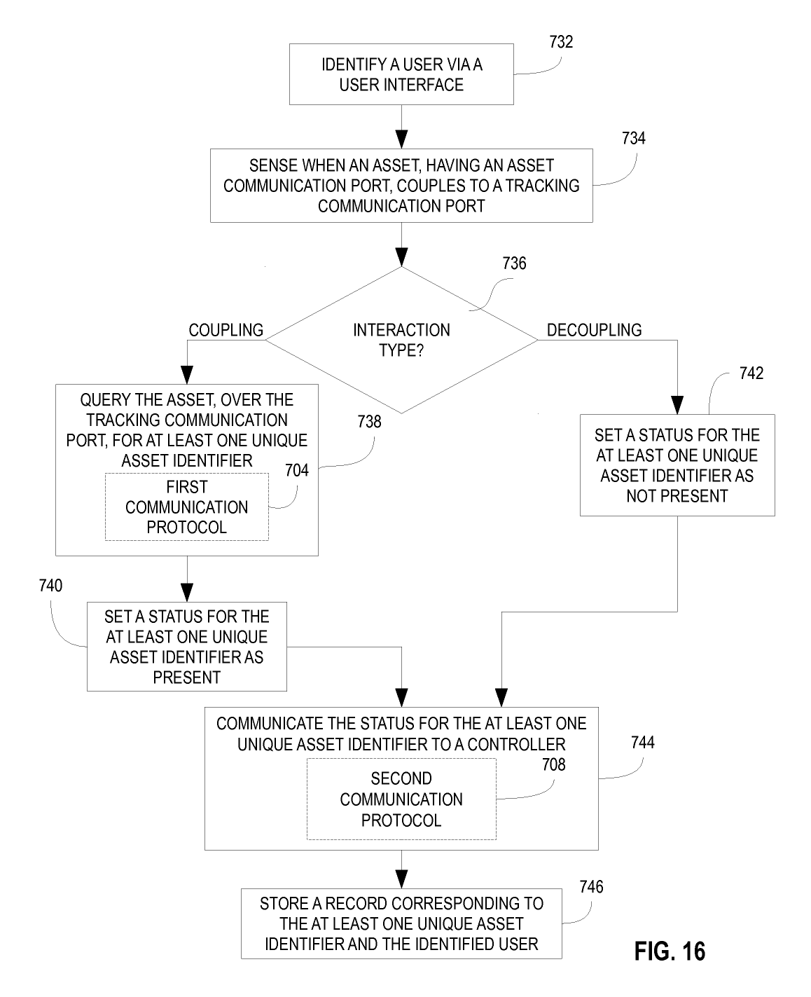

FIG. 16 illustrates another embodiment of a method for asset management. In step 732, a user is identified via a user interface. As discussed previously, examples of a suitable user interface include, but are not limited to a keypad, a fingerprint reader, a proximity card reader, an iris identification device, a retinal scanning identification device, a hand shape identification device, and a magnetic card reader. In step 734, an asset having an asset communication port is sensed when it interacts with a tracking communication port. Depending on the embodiment, “querying the asset” can mean the asset is queried via the tracking communication port connection, or it can mean the asset communication port is queried via the tracking communication port/asset communication port connection. The first case might occur with a USB type connection, while the second case might occur, for example, where an RFID tag has been added to an asset. This can be accomplished, for example, with translation circuitry coupled to a tracking communication port as discussed above. The interaction between the asset communication port and the tracking communication port can be a coupling, for example, when the asset is returned and plugged into the tracking communication port. Alternatively, the interaction between the asset communication port and the tracking communication port can be a decoupling, for example, when the asset is removed and unplugged from the tracking communication port.

A determination 736 is made whether or not the sensed interaction of the asset communication port with the tracking communication port is a coupling or a decoupling. If the interaction comprises a coupling, then in step 738, the asset is queried over the tracking communication port for at least one unique asset identifier. This can also be accomplished, for example, with translation circuitry coupled to the tracking communication port as discussed above. In some embodiments, this query may occur using a first communication protocol 734 as discussed previously. In step 740, a status for the at least one unique asset identifier is set as present. Alternatively, if determination 736 finds that the interaction comprises a decoupling, then in step 742, the status for the at least one unique asset identifier is set as not present. Whether the interaction was a coupling or a decoupling, after the status is set to present or not present, the status for the at least one unique asset identifier is communicated to a controller in step 744. In some embodiments, this communication may occur using a second communication protocol 708 as also discussed previously. In step 746, a record is stored corresponding to the at least one unique asset identifier and the identified user. Such a record could be stored in a database or other storage or memory. One example of a record stored could include the name and/or identification of the user identified via the user interface and a list of one or more assets removed and/or returned by the user. Such a record may also include information showing the date/time the transaction took place and/or an alarm or report status for the transaction.

Having thus described several embodiments of the claimed invention, it will be rather apparent to those skilled in the art that the foregoing detailed disclosure is intended to be presented by way of example only, and is not limiting. Many advantages for the systems and methods for communication port based asset management have been discussed. Various alterations, improvements, and modifications will occur and are intended to those skilled in the art, though not expressly stated herein. These alterations, improvements, and modifications are intended to be suggested hereby, and are within the spirit and the scope of the claimed invention. As one example, it may be desirable to provide a feedback indicator, such as a light emitting diode (LED), near each asset tracking port or easily associated with each asset tracking port so that a controller may enable the feedback indicator following user authentication to show then which asset(s) may be validly removed by the user. In some embodiments, if the asset has a screen or other feedback indicator built into the asset, then the controller might send a command to the asset, over the tracking communication port/asset communication port connection to turn on a feedback indicator on the device (for example, by turning on the display of the device) when it's authorized user has authenticated with the system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for asset management, comprising:
at least one tracking communication port selectively coupled to an asset communication port;
a database configurable to store one or more asset records;
a user interface; and
a controller coupled to the at least one tracking communication port, the database, and the user interface, wherein the controller:
identifies a user via the user interface;
senses when an asset, having the asset communication port, couples to the at least one tracking communication port via its asset communication port;
queries the asset for at least one unique asset identifier; and
stores a record corresponding to the at least one unique asset identifier.

2. The system of claim 1, wherein the at least one tracking communication port comprises a radio frequency (RF) port.

3. The system of claim 2, wherein the RF port comprises a radio frequency identification (RFID) port.

4. The system of claim 2, wherein the RF port comprises a near field communication (NFC) port.

5. The system of claim 2, further comprising a receptacle configured to receive a car fob, wherein the RF port includes a radio antenna mounted in the receptacle, and the asset communication port includes a transmitter of a car fob.

6. The system of claim 5, wherein the receptacle includes a drawer mounted in a cabinet, the drawer being supported by a bracket attached to the cabinet, the drawer including a cavity sized to receive a car fob, and the antenna is attached to at least one of the bracket and the cabinet.

7. The system of claim 6, wherein the RF port further comprises:
a radio frequency identification (RFID) front end;
an RFID clock coupled to the RFID front end;
an antenna driver and tuning circuitry coupled to a transmission port and a reception port of the RFID front end; and
wherein the antenna is coupled to the antenna driver and tuning circuitry.

8. The system of claim 1, wherein the user interface comprises an interface selected from the group consisting of a keypad, a fingerprint reader, a proximity card reader, an iris identification device, a retinal scanning identification device, a hand shape identification device, and a magnetic card reader.

9. The system of claim 1, wherein the at least one unique asset identifier comprises a media access control (MAC) address.

10. The system of claim 1, wherein the at least one unique asset identifier comprises a vendor identification (VID).

11. The system of claim 1, wherein the at least one unique asset identifier comprises a product identification (PID).

12. The system of claim 1, wherein the at least one unique asset identifier comprises a product serial string.

13. The system of claim 1, wherein the at least one unique asset identifier comprises a vendor identification (VID), a product identification (PID), and a product serial string.

14. An asset tracking device, comprising:
at least one tracking communication port configured to be removably coupled to an asset communication port; and
translation circuitry coupled to the at least one tracking communication port and including a sensor that selectively senses when an asset, having the asset communication port, couples to the at least one tracking communication port via its asset communication port, the translation circuitry querying the asset when present for at least one unique asset identifier and presenting the at least one unique asset identifier to a controller.

15. The asset tracking device of claim 14, wherein the at least one tracking communication port comprises a radio frequency (RF) port.

16. The asset tracking device of claim 15, wherein the RF port comprises a radio frequency identification (RFID) port having:
a radio frequency identification (RFID) front end;
an RFID clock coupled to the RFID front end;
an antenna driver and tuning circuitry coupled to a transmission port and a reception port of the RFID front end; and
an antenna coupled to the antenna driver and tuning circuitry.

17. The asset tracking device of claim 15, wherein the RF port comprises a near field communication (NFC) port.

18. A security asset manager, comprising:
a communication bus;
at least one tracking communication port configured to be removably coupled to an asset communication port;
translation circuitry coupled to the at least one tracking communication port and the communication bus, wherein the translation circuitry is configured to:
sense when an asset, having the asset communication port, couples to the at least one tracking communication port via its asset communication port;
query the asset for at least one unique asset identifier;
present the at least one unique asset identifier to the communication bus; and
a controller coupled to the communication bus, wherein the controller is configured to determine when the asset is coupled to the at least one tracking communication port by receiving the asset's at least one unique asset identifier from the communication bus.

19. The security asset manager of claim 20, wherein the communication bus comprises a 1-Wire communication bus.

20. The security asset manager of claim 20, wherein the at least one tracking communication port comprises a radio frequency (RF) port.
